(19) United States
(12) Patent Application Publication
(10) Pub. No.: US 2010/0048766 A1
(43) Pub. Date: Feb. 25, 2010

(54) HALOGEN-FREE PHOSPHOROUS EPOXY RESIN COMPOSITION

(76) Inventors: Yu Hsain Cheng, Hsinchu City (TW); We Ming Te, Hsinchu County (TW); Gary Yonggang Min, Grove City, OH (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/162,611

(22) PCT Filed: Feb. 22, 2007
(86) PCT No.: PCT/US07/04837

§ 371 Date: Apr. 8, 2009

(30) Foreign Application Priority Data
Feb. 23, 2006 (TW) 95106033

(51) Int. Cl. C08L 63/00; C09J 163/00

(52) U.S. Cl. 523/451

(57) ABSTRACT

The present invention relates to a polyphosphate-containing halogen-free adhesive, primarily used as an adhesive. The composition comprising the polyphosphate group compounds which effectively meets the needs for environmental protection and flame retardancy, and the high flexibility and flame retardancy of the adhesive made it suitable for using on printed circuit board, especially the flexible printed circuit board.

### FIELD OF INVENTION

The present invention relates to a polyphosphate-containing halogen-free adhesive. Specifically, it relates to a halogen-free adhesive containing polyphosphate derivatives compounds applicable to flexible printed circuit board.

### BACKGROUND OF THE INVENTION

The printed circuit board is the very foundation for all electronic products. In the manufacturing industry, the unleaded and halogen-free materials are becoming the key development projects, in order to respond to the trend of environmental protection concerns around the world.

The Flexible Printing Circuit (FPC, which also called as flexible board in short) is a printed circuit board made with a flexible substrate, which has been widely used for electronic products such as notebooks, cellular phones, liquid crystal displays, and digital cameras, for its flexibility, three dimensional wiring capability in the limited space and special shape provided, that meets the demand for light in weight, thin, short, and small in size.

The application of a polymerizable resin as the adhesive is a well-known method. The adhesive used for printed circuit board, especially for the adhesion of the flexible printed circuit board is generally a resin without flame retardancy, and additional flame retardant is combined to achieve flame retardancy effects.

Currently, the commonly used adhesive is added with a bromine flame retardant in order to obtain the flame retardancy effects (for example, to comply to the UL94 VTM-0 standard). In recent years, the use of a halogen-free component in the composition has became one of the standards as the result of environmental protection concerns around the world, in order to protect the environment. In the past, in order to provide flame retardancy to electronic materials, a large amount of powdery has been often added, which not only reduces flexibility of the resin solids, but also does not follow the environmental protection trend, because its bromine component and the dioxins produced during the burning process.

In order to follow today's environmental protection trend, the composition of the adhesive must be a halogen-free compound. However, not all halogen-free flame retardant is suitable for flexible printed circuit board, since the flexible printed circuit board must undergone the high temperature processing procedure and the wet processing procedure during the manufacturing process. For example, the Coverlay requires protecting the metal wires from oxidization caused by ambient moisture. Therefore, the flexible printed circuit board must possess high temperature resistance and humidity resistance. As for the commercially available commonly used phosphate flame retardant, the small molecule does not have high temperature resistance property and tends to absorb water. For example, the R.O.C. Patent No. I240746 disclosed a triethylphosphate, that is a phosphate flame retardant, which is not suitable for the flexible printed circuit board manufacturing process, because its boiling point is only at 216 C, it dissolves in water, and generates decomposition with the temperature increase.

Therefore, the present invention has developed an adhesive with has flame retardancy, high flexibility, high temperature resistance, and humidity resistance. This adhesive is developed to replace the original bromine adhesive used for flexible printed circuit board.

### SUMMARY OF THE INVENTION

In order to solving the environment contaminating problems caused by the halogen-containing materials, the purpose of the present invention is to develop a halogen-free adhesive, that will replace the bromine-containing adhesive used for the printed circuit board, especially the flexible printed circuit board. The adhesive of the present invention must possess high flexibility, humidity resistance, flame retardancy, and excellent adhesive strength to metals and plastic substrates.

In order to attain the above-mentioned purpose, the present invention provides a polyphosphate-containing halogen-free adhesive, that it comprises:

at least one part of halogen-free epoxy resin;

one part of curing agent;

one part of catalyst;

one part of elastomer;

and one part of polyphosphate group halogen-free flame retardant. Among them, the above polyphosphate group halogen-free flame retardant includes an ammonium polyphosphate (APP), a melamine polyphosphate (MPP), a Melamine Pyrophosphate or mixture thereof.

The above mentioned composition can further contain one part of inorganic powder.

The above composition can also further include one part of silane compound.

The polyphosphate-containing halogen-free adhesive of the present invention uses polyphosphate flame retardant in that its polymer has higher heat-resistance and humidity resistance, compared with a phosphate; the high flexibility, humidity resistance, and flame retardancy made it suitable for using as an adhesive for the printed circuit board, especially as an adhesive for the flexible printed circuit board.

### DETAILED DESCRIPTION OF THE INVENTION

A type of polyphosphate-containing halogen-free composition of the present invention comprises: at least one part of halogen-free epoxy resin; one part of curing agent; one part of catalyst; one part of elastomer; and one part polyphosphate-containing halogen-free flame retardant.

The components of the composition of the present invention include the following: 100 wt % halogen-free epoxy resin; 3˜20 wt % curing agent; 0.2˜2.5 wt % catalyst; 20˜50 wt % elastomer; and 5˜90 wt % polyphosphate-containing halogen-free flame retardant.

In the preferred embodiment, the components of the composition of the present invention comprise: 100 wt % halogen-free epoxy resin; 7˜16 wt % curing agent; 0.2˜1 wt % catalyst; 20˜40 wt % elastomer; and 10˜50 wt % polyphosphate-containing halogen-free flame retardant.

To improve the flame retardancy of the composition, the halogen-free phosphorus epoxy resin is the preferred halogen-free epoxy resin. In the preferred embodiment, the halogen-free phosphorus epoxy resin has the structure as shown in the following formula (I):

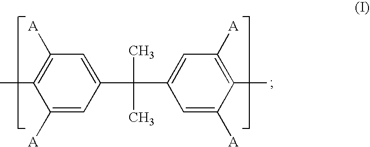

wherein A is

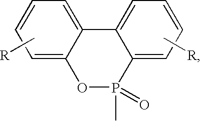

or a hydrogen, or a halogen-free substituted alkyl group, or alkoxy group; R is a hydrogen, unsubstituted or halogen-free substituted alkyl group or alkoxy group; when R is a hydrogen, then 9,10-dihydro-9-oxa-10-phosphaphenanthrene-10-oxide, DOPO.

The curing agent stated in the present invention, which is a hardening or solidifying material well-known by people in the art, which includes, but not limited to diaminodiphenyl sulfone (DDS), dicyandiamide (DICY), adipic dihydrazide (ADH), and phenol—aldehyde resin or mixture thereof.

The elastomer stated in the present invention, which is a substance used for providing flexibility as well-known by people in the art, which includes, but not limited to the carboxy terminated butadiene acrylonitrile (CTBN), amine terminated butadiene acrylonitrile (ATBN), polyamine, polyester (for example: PET resin) or the mixture thereof.

The catalyst stated in the present invention, which is a substance used for catalyzing the hardening and solidification reaction as is well-known by people in the art, which includes, but not limited to 2-methyl imidazole (2MI), 2-ethyl-4-methyl imidazole (2E4MI), triphenyl phosphate (TPP), or mixture thereof.

The polyphosphate-containing halogen-free flame retardant of the present invention includes ammonium polyphosphate (APP), (melamine polyphosphate (MPP), Melamine Pyrophosphate, or mixture thereof. Compounds containing more than two phosphoric molecular structures in the its molecular structures. In the preferred embodiment, the flame retardant of the present invention uses ammonium polyphosphate, which has better water-absorbing resistance, higher heat-resistance and stronger adhesive power in the large molecules and the has a benzene ring structure, compared with other flame retardants.

The polyphosphate-containing halogen-free composition of the present invention is capable of making adjustment to the composition used in the adhesive by combining two types of halogen-free epoxy resins. For example, by combining a halogen-free epoxy resin with average epoxy equivalent less than 300 and a halogen-free epoxy resin with average epoxy equivalent greater than 300, and either one of the average epoxy equivalent to either one of the combination ratio of these two is not required to be set as restricted, that is, if the addition amount of the halogen-free epoxy resin with average epoxy equivalent amount less than 300 increased, it is possible that the other halogen-free epoxy resin is selected among the halogen-free epoxy resins with higher average epoxy equivalent.

The composition of the present invention further comprises a filler, which is a substance used for improving flame retardancy effectiveness as well-known by people in the art, which includes, but not limited to, for example, the inorganic powders such as magnesium hydroxide, silica, magnesium silicate hydroxide (Talc), Nano-Clay, Titanium Dioxide, boron nitride (BN), and mixture thereof.

The composition of the present invention further comprises a coupling agent. The function of the coupling agent improves the adhesive property of the composition and the surface of the metal, and enhances heat-resistant and water-resistant properties of the composition. A concrete examples of that is the silane group compound.

The composition of the present invention can be coated homogeneously on a substrate when is intended to use. The thickness of the coating is ranged between 5 to 50 μm, and the substrate might be metal or plastic thin films. After the coating is baked on the plastic substrate (the temperature range is between 70° C. to 200° C.) to a degree ready for use, a multi-layer film composition (a) is obtained. If the composition coating is formed on a copper foil (the temperature range is between 70° C. to 200° C.), a multi-layer film composition (b) can be obtained. A coverlay for the flexible circuit board is formed after laminating the composition (a) with a membrane. When the composition (a) is press-fit with a copper foil and allowed for hardening, then a 3-layer product is formed. A back rubber copper foil is formed after laminating the composition (b) with the membrane.

After the halogen-free composition of the present invention is coated on a polyamide film and crimped with the copper foil at a high temperature through laminating and pressing with heat, it is provided with the following characteristics: flame retardancy reached the UL94VTM-0 standard, peel strength at 90° is greater than 0.6 kg/cm (IPC TM650 standard), MIT is greater than 800 cycles (JIS C6471 R=0.38 mm), high temperature proof (Solder float at 260° C., 10 sec; IPC TM650), high temperature and damp proof (at 90° peel strength at 85% RH/85□24hr is greater than 0.6 kg/cm).

In the preferred embodiment, the halogen-free composition of the present invention coated on a polyamide film and crimped with the copper foil at a high temperature through laminating and pressing with heat, it has the following characteristics: flame retardancy reaches the UL94VTM-0 standard, peel strength at 90° is greater than 1.0 kg/cm (IPC TM650 standard), MIT is greater than 1,000 cycles (JIS C6471 R=0.38 mm), high temperature proof (Solder float at 288° C., 10 sec; IPC TM650), high temperature and damp proof (90° peel strength at 85% RH/85□24hr is greater than 1 kg/cm).

### Examples

The following working examples are provided for further clarify the advantages of the present invention, and it is not intended to limiting the scope of the invention.

### Example 1

A composition comprising polyphosphate-containing halogen-free compound as a flame retardant is prepared by dissolving 20 wt % CTBN rubber in 260 wt % methyl ethyl ketone (MEK) solvent, then add 100 wt % bis-phenol A epoxy resin (comprising 40 wt % Nanya epoxy resin NPEL-128E and 60 wt % NPES-902), 16.4 wt % 4,4′-diaminodiphenyl sulphone (DDS) as the curing agent, 0.5 wt % 2-Ethyl-4-dimethylimidazole (2E4MI) as the catalyst, 1.2 wt % silane compound Dow Corning Z6020 as the coupling agent, and 50 wt % ammonium polyphosphate (APP) (purchased from NISSAN Chem, PMP-100) to the aforementioned MEK solution, then grind the solution in a grinder for 4 hours, and 37 wt. % ˜45 wt. % composition solution is obtained.

Test

Coat the aforementioned composition solution on a polyimide film with a coating machine, bake it in an over at 75° C. for 10 minutes, after press the adhesive layer with the copper foil at a high temperature of 170° C., a flexible board composition is provided for various material property tests.

The solder float test was conducted according to IPC TM650 2.4.9 Method C standard; MIT test was conducted according to the method in compliance with JIS C6471 standard R=0.38mm; the peel strength test was conducted according to the method in compliance with IPC TM650 2.4.9 Method A; flammability test was conducted according to the method in compliance with UL94 VTM standard; and resin flow test was conducted according to the method in compliance with IPC TM650 2.3.17.1 standard.

### Example 2

A composition comprising polyphosphate-containing halogen-free compound as a flame retardant is prepared as in example 1 except 40 wt % CTBN rubber and 300 wt % MEK were used.

The test method is the same as in example 1.

### Example 3

A composition comprising polyphosphate-containing halogen-free compound as a flame retardant is prepared as in example 1 except 60 wt % elastomer rubber and 310 wt % MEK were used.

The test method is the same as in example 1.

Table 1 shows the property measurement comparison of the adhesive containing different CTBN weight ratio in the compositions of the examples 1˜3. It is clear from the table that although the peel strength and resin flow property enhanced, MIT decreases, along with the increased amount of elastomer (CTBN).

TABLE 1

| | Example | | |
|---|---|---|---|
| | 1 | 2 | 3 |
| CTBN | 20 | 40 | 60 |
| wt % | | | |
| Peel | 0.7 | 0.9 | 1.3 |
| strength kg/cm | | | |
| Resin flow | 445 | 258 | 240 |
| (μm) | | | |
| Folding | 1079 | 1177 | 603 |
| Endurance Test | | | |
| MIT (cycles) | | | |

### Example 4

A composition comprising polyphosphate-containing halogen-free compound as a flame retardant is prepared by dissolving_{—}40 wt % CTBN in 260 wt % methyl ethyl ketone (MEK), then add 100 wt % bis-phenol A epoxy resin (comprising 50 wt % epoxy resin NPEL-128E from Nanya and 50 wt % NPES-902), 7 wt % DICY, 0.5 wt % 2E4MI, 1.2 wt % Dow Corning Z6020 silane compound, and 50 wt % ammonium polyphosphate (APP) (NISSAN Chem, PMP-100) to the aforementioned MEK solution, then grind the solution in a grinder for 4 hours, and 37% ˜45% composition solution is obtained.

The test method is the same as in example 1.

### Example 5

A halogen-free composition is prepared as in example 4 except 90 wt % Mg(OH)₂ was used to replace ammonium polyphosphate (APP).

The test method is the same as in example 1.

### Example 6

A halogen-free composition composition is prepared as in example 4 except 120 wt % SiO₂ was used to replace the ammonium polyphosphate (APP).

The test method is the same as in example 1.

Table 2 shows the property measurement comparison of the adhesive containing different flame retardant in the compositions of the examples 4˜6. It is clear from the Table that the flammability test standard UL94VTM0 can be achieved with the dosage of polyphosphate (ammonium polyphosphate, MPP, NISSAN Chem., PMP-100, phosphorus content: 14.5% , nitrogen content: 45% ), which is the half amount of that a hydroxide or silicon oxide.

TABLE 2

Example

| | 4 | 5 | 6 |
|---|---|---|---|
| Flame | MPP | MgOH₂ | Silica |
| retardant (wt %) | (50) | (90) | (120) |
| Flammability | Pass | Failed | Failed |
| test UL 94VTM0 | | | |

### Example 7

A composition comprising polyphosphate-containing halogen-free compound as a flame retardant is prepared by dissolving 20 wt % CTBN in 280 wt % methyl ethyl ketone (MEK) solvent, then add 100 wt % epoxy resin (comprising 40 wt % Nanyaepoxy resin NPEL-134, 40 wt % NPES-901, and 20 wt % NPPN-631), 7 wt % DICY, 0.5 wt % 2E4MI, and 30 wt % ammonium polyphosphate (APP) (NISSAN Chem., PMP-100; phosphorus content: 14.5% , nitrogen content: 45% ), 5 wt % SiO2, and 5 wt % Nanoclay into the aforementioned MEK solution, then grind the solution in a grinder for 4 hours, and 37 wt. % ˜45 wt. % composition solution is obtained.

The test method is the same as in example 1.

### Example 8

A composition comprising polyphosphate-containing halogen-free compound as a flame retardant is prepared as in example 7 except changed to 40 wt % ammonium polyphosphate (APP) (NISSAN Chem., PMP-100).

The test method is the same as in example 1.

### Example 9

A composition comprising polyphosphate-containing halogen-free compound as a flame retardant is prepared as in example 7 except changed to 80 wt % ammonium polyphosphate (APP) in different product series number containing less phosphorus (NISSAN Chem., PMP-200; phosphorus content: 10.6% ).

The test method is the same as in example 1.

### Example 10

A composition comprising polyphosphate-containing halogen-free compound as a flame retardant is prepared as in example 7 except changed to 90 wt % ammonium polyphosphate (APP) of different product type containing less phosphorus (NISSAN Chem., PMP-200).

The test method is the same as in example 1.

Table 3 shows the property measurement comparison of the adhesive containing different flame retardant in the compositions of the examples 7˜10. It is clear from the table that polyphosphate containing comparatively high phosphorus content can reach to flame retardancy standard with a small dosage.

TABLE 3

| | Example | | | |
|---|---|---|---|---|
| | 7 | 8 | 9 | 10 |
| Flame retardant | PMP100 | PMP100 | PMP200 | PMP200 |
| (wt %) | (30) | (40) | (80) | (90) |
| Flammability | Failed | Pass | Failed | Pass |
| test UL 94VTM0 | | | | |

### Example 11

A composition comprising polyphosphate-containing halogen-free compound as a flame retardant retardant is prepared by dissolving 40 wt % CTBN rubber in 280 wt % MEK solvent, then add 100 wt % bis-phenol A epoxy resin (comprising 40 wt % Nanya epoxy resin NPEL-128E and 60 wt % NPES-902),15.5 wt % DDS, 0.5 wt % 2E4MI, 50 wt % ammonium polyphosphate (APP) (NISSAN Chem, PMP-100) to the aforementioned MEK solution, then add 1.2 wt % Dow Corning Z6020 as the coupling agent. The chemical formula of Dow Corning Z6020 is shown below:

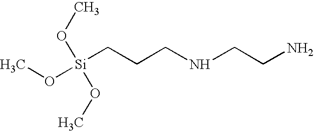

Then, grind the solution in a grinder for 4 hours, and 37 wt. % ˜45 wt. % composition solution is obtained.

The test method is the same as in example 1.

### Example 12

A composition comprising polyphosphate-containing halogen-free compound as a flame retardant is prepared as in example 11 except DDS dosage was changed to 14.5 wt % and 2.4 wt % coupling agent Dow Corning Z6020 was added.

The test method is the same as in example

### Example 13

A composition comprising polyphosphate-containing halogen-free compound as a flame retardant is prepared as in example 11 except DDS dosage was changed to 14.5 wt % and 2.4 wt % coupling agent Dow Corning Z6020 and 5 wt % Dow Corning Z6040 were added. The chemical formula of Dow Corning Z6020 is shown below:

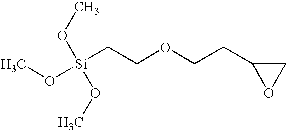

Dow Corning Z6040.

The test method is the same as in example 1.

It is clear from Table 4 that the addition of a coupling agent Dow Corning Z6020 Silane in the composition of the working examples 11˜13 improves heat resistant property (by conducting solder float test at 288° C., 10 sec.). Also, by adding a coupling agent, resin flow can be reduced, and temperature and humidity resistance (environment test, 85% RH/85 24 hours, peel strength reached 1.4 kg/cm). The resin flow can be further reduced by additionally adding Z6040 coupling agent as the case of the working example 13.

TABLE 4

| | Example | | |
|---|---|---|---|
| | 11 | 12 | 13 |
| Z6020 coupling agent, wt % | 1.2 | 2.4 | 2.4 |
| Z6040 coupling agent, wt % | None | None | 5 |
| Peel strength, kg/cm | 1.5 | 1.4 | 1.4 |
| Solder Float Test | Pass | Pass | Pass |
| (288° C. - 10 sec.) | | | |
| Resin flow test um | 355 | 260 | 90 |
| Environment test 85/85% RH | 1.4 | 1.5 | 1.3 |
| Peel strength, kg/cm | (24 h) | (24 h) | (24 h) |

### Example 14

A composition comprising polyphosphate-containing halogen-free compound as a flame retardant is prepared by dissolving 40 wt % CTBN rubber in 280 wt % MEK solvent, then add 100 wt % bis-phenol A epoxy resin (comprising 50 wt % Nanya epoxy resin NPEL-134 and 50 wt % NPES-907), 8 wt % DDS, 0.5 wt % 2E4MI, 50 wt % ammonium polyphosphate (APP) (NISSAN Chem, PMP-100) to the aforementioned MEK solution. Then, grind the solution in a grinder for 4 hours, and 37 w/t % ˜45 w/t % composition solution is obtained.

The test method is the same as in example 1.

### Example 15

A composition comprising polyphosphate-containing halogen-free compound as a flame retardant is prepared as in example 14 except DDS dosage was changed to 7 wt % DDS and 1.2 wt % coupling agent Dow Corning Z6020 was added additionally.

The test method is the same as in example 1.

### Example 16

A composition comprising polyphosphate-containing halogen-free compound as a flame retardant is prepared as in example 14 except the addition of 100 wt % bis-phenol A epoxy resin was changed to 50 wt % Nanya epoxy resin NPEL-128E and 50 wt % NPES-907.

The test method is the same as in example 1.

### Example 17

A composition comprising polyphosphate-containing halogen-free compound as a flame retardant is prepared as in example 14 except the addition of 100 wt % bis-phenol A epoxy resin was changed to 50 wt % Nanya epoxy resin NPEL-128E and 50 wt % NPES-907, DDS dosage was changed to 7 wt % and 1.2 wt % coupling agent Dow Corning Z6020 were added additionally.

The test method is the same as in example 1.

It is clear from Table 5 that the addition of a coupling agent Dow Corning Z6020 Silane into the composition as in the case of the working examples 14˜17 improves heat resistant property, and the same level of properties maintained 10 seconds after conducting the solder float test at 288° C.

TABLE 5

| | Example | | | |
|---|---|---|---|---|
| | 14 | 15 | 16 | 17 |
| Bis-phenol A epoxy | Epoxy | Epoxy | Epoxy | Epoxy |
| resin | equivalent | equivalent | equivalent | equivalent |
| (wt %) | 240:1650 | 240:1650 | 180:1650 | 180:1650 |
| | (50:50) | (50:50) | (50:50) | (50:50) |
| Z6020 | None | 1.2 | None | 1.2 |
| coupling agent | | | | |
| wt % | | | | |
| Peel | 0.7 | 0.9 | 0.8 | 0.8 |
| strength, kg/cm | | | | |
| After Solder | 0.5 | 0.9 | 0.2 | 0.7 |
| (288° C. - 10 sec.), | | | | |
| Peel strength test | | | | |
| kg/cm | | | | |

### Example 18

A composition comprising polyphosphate-containing halogen-free compound as a flame retardant is prepared as in example 14 except the MEK amount changed to 300 w/t part, DDS changed to 12.6 w/t part, and added 1.2 wt % coupling agent Dow Corning Z6020 and 20 wt % polyester (purchased from TOYOBO Vylon 200) as the humidity resistant.

### Example 19

A composition comprising polyphosphate-containing halogen-free compound as a flame retardant is prepared as in example, except the MEK amount changed to 330 w/t part, DDS changed to 12.6 w/t part, and added 1.2 wt % coupling agent Dow Corning Z6020 and 40 wt % polyester (purchased from TOYOBO Vylon 200).

It is clear from Table 6 that the addition of a humidity resistant (polyester) into the composition as in the case of the working examples 15, 18, and 19 improves high temperature and high humidity resistance properties of the polyester composition.

TABLE 6

| | Example | | |
|---|---|---|---|
| | 16 | 18 | 19 |
| Polyester (RV200), wt % | None | 20 | 40 |
| Environment test 85/85% RH | 0.6 | 0.7 | 1.0 |
| Peel strength kg/cm | (58 h) | (58 h) | (58 h) |

As a summary of the results of the aforementioned working examples and comparative examples, the composition using halogen-free polyphosphate as the flame retardant developed by the present invention through a long-period of diligent research can be applied as an adhesive for printed circuit board. Especially, when used as an adhesive for flexible printed circuit board, it provides high flexibility, humidity resistance and flame retardancy, and the additional combination of a coupling agent enhances high peel strength and heat resistant properties possessed as the adhesive.

All characteristics disclosed in the specification can be combined with other methods, each of the characteristic disclosed in the present invention can be selectively substituted by the characteristics with identical, equivalent, similar purposes. Therefore, except the particularly obvious characteristics, the characteristics disclosed in the present specification are only one of the examples of the equivalent or similar characteristics.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A type of composition containing halogen-free polyphosphate as the flame retardant is used as an adhesive, and the composition comprises:
100 wt % at least epoxy resin and which is used as the standard;
3˜20 wt % curing agent;
0.2˜2.5 wt % catalyst;
20˜50 wt % elastomer; and 5˜90 wt % polyphosphate halogen-free flame retardant.

2. A composition of claim 1 comprises:
100 wt % at least epoxy resin and which is used as the standard;
7˜16 wt % curing agent;
0.2˜1 wt % catalyst;
20˜40 wt % elastomer; and 10˜50 wt % polyphosphate halogen-free flame retardant.

3. A composition of claim 3, wherein said epoxy resin is a halogen-free epoxy resin.

4. A composition of claim 3, wherein said halogen-free epoxy resin has the structure as shown in the following formula (I). 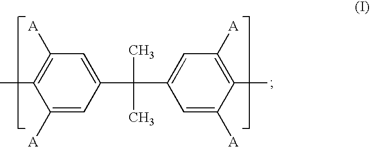
wherein A is 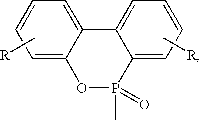
or a hydrogen, or a halogen-free substituted, alkyl group, or alkoxy group; R is the hydrogen, unsubstituted or halogen-free substituted alkyl group or alkoxy group; when R is a hydrogen, then 9,10-dihydro-9-oxa-10-phosphaphenanthrene-10-oxide, DOPO.

5. A composition of claim 1, wherein said curing agent includes diaminodiphenyl sulfone (DDS), dicyandiamide (DICY), adipic dihydrazide (ADH), and phenol—aldehyde resin or mixture thereof.

6. A composition of claim 1, wherein said elastomer includes the carboxy terminated butadiene acrylonitrile (CTBN), amine terminated butadiene acrylonitrile (ATBN), polyamine, polyethylene terephthalate or mixture thereof.

7. A composition of claim 1, wherein said catalyst includes 2-methyl imidazole (2MI), 2-ethyl-4-methyl imidazole (2E4MI), triphenyl phosphate (TPP) or mixture thereof.

8. A composition of claim 1, wherein said polyphosphate halogen-free flame retardant includes ammonium polyphosphate (APP), melamine polyphosphate (MPP), Melamine Pyrophosphate or mixture thereof.

9. A composition of claim 1, wherein an inorganic powder can be further included.

10. A composition of claim 9, wherein said inorganic powder includes magnesium hydroxide, silica, magnesium silicate hydroxide (Talc), Nano-Clay, Titanium Dioxide, boron nitride (BN), or mixture thereof.

11. A composition of claim 1, wherein said composition further includes a coupling agent such as the silane group compound.

12. A composition of claim 1, wherein a polyester compound may be further included as a humidity resistant.

13. A composition of claim 1, wherein said composition is used as an adhesive for printed circuit board.

14. A composition of claim 1, wherein said printed circuit board is a flexible printed circuit board.

15. A type of halogen-free composition containing polyphosphate derivatives group compound is used as an adhesive, and the composition comprises: one part of halogen-free epoxy resin, one part of curing agent, one part of catalyst, one part of elastomer, and one part polyphosphate derivatives group halogen-free flame retardant. After the halogen-free composition of the present invention coated on a polyamide film and crimped with the copper foil at a high temperature through laminating and pressing with heat, it has the following characteristics: flame retardancy meets the UL94VTM-0 standard, peel strength at 90° is greater than 0.6 kg/cm (IPC TM650 standard), MIT is greater than 800 cycles (JIS C6471 R=0.38mm), high temperature proof (Solder float 260° C., 10 sec; IPC TM650), high temperature and damp proof (90° peel strength at 85% RH/85 24hr is greater than 0.6kg/cm).
